(19) United States
(12) Patent Application Publication
(10) Pub. No.: US 2013/0124174 A1
(43) Pub. Date: May 16, 2013

(54) INTERNAL PARALLELISM IN A PARALLEL DISCRETE EVENT SIMULATION FOR SPACE SITUATIONAL AWARENESS

(71) Applicants: David R. Jefferson, San Ramon, CA (US); Alexander Pertica, Livermore, CA (US); Matthew C. Brown, Seattle, WA (US); Willem H. De Vries, Livermore, CA (US); Benjamin J. Fasenfest, Union City, CA (US); Matthew A. Horsley, Danville, CA (US); Ming Jiang, Dublin, CA (US); James R. Leek, Livermore, CA (US); JoAnne L. Levatin, Livermore, CA (US); Segei Nikolaev, Sacramento, CA (US); Scot S. Olivier, Livermore, CA (US); Donald William Phillion, Dublin, CA (US); Harry K. Springer, Pleasanton, CA (US)

(72) Inventors: David R. Jefferson, San Ramon, CA (US); Alexander Pertica, Livermore, CA (US); Matthew C. Brown, Seattle, WA (US); Willem H. De Vries, Livermore, CA (US); Benjamin J. Fasenfest, Union City, CA (US); Matthew A. Horsley, Danville, CA (US); Ming Jiang, Dublin, CA (US); James R. Leek, Livermore, CA (US); JoAnne L. Levatin, Livermore, CA (US); Segei Nikolaev, Sacramento, CA (US); Scot S. Olivier, Livermore, CA (US); Donald William Phillion, Dublin, CA (US); Harry K. Springer, Pleasanton, CA (US)

(21) Appl. No.: 13/488,377

(22) Filed: Jun. 4, 2012

Related U.S. Application Data
(60) Provisional application No. 61/493,323, filed on Jun. 3, 2011.

(51) Int. Cl. G06G 7/48

(52) U.S. Cl. 703/6

(57) ABSTRACT

An internally parallel PDES (“IP-PDES”) system performs logical processes in parallel and further performs the internal processing of at least one logical process in parallel. Because the IP-PDES system is PDES-based, each logical process may have its processing performed in parallel with the other logical processes. The IP-PDES system allows for certain logical processes to be designated as internally parallel meaning that the logical process, referred to as an IP logical process, has its internal processing also performed in parallel. The IP-DES system allocates multiple nodes for such an IP logical process so that executable code of the IP logical process executes in parallel at the allocated nodes to simulate the occurrence of an event. Internal parallelism within a PDES may help overcome resource limitations and help speed up the overall simulation.

### CROSS-REFERENCE TO RELATED APPLICATION(S)

This application claims the benefit of U.S. Provisional Patent Application No. 61/493,323 filed Jun. 3, 2011, entitled TESTBED ENVIRONMENT FOR SPACE SITUATIONAL AWARENESS, which is incorporated herein by reference in its entirety.

### STATEMENT REGARDING FEDERALLY SPONSORED RESEARCH

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND

Space Situational Awareness (“SSA”) programs rely on precise knowledge of the state and location of objects orbiting the earth for a variety of applications that may include predicting collisions (or near misses) between satellites and space junk, location and timing as a satellite falls to earth, a rocket's intercept of a satellite, and so on. The Space Surveillance Network (“SSN”) is a worldwide network of devices, such as radar and telescope sensors that may be ground-based or space-based, computers, databases, and communications links, involved in discovering, observing, and tracking such orbiting objects. The performance (e.g., accuracy and timeliness of information) and corresponding cost of the SSN depends in large part on the number, placement, and characteristics of the devices of the SSN, referred to as the design of the SSN. Some of the SSN sensors (e.g., Ground-Based Electro-Optical Deep Space Surveillance “GEODSS”) are dedicated to the SSA observations full time, but others (e.g., most radars) are only available for SSA observations part time. One useful metric for evaluating performance of a design of the SSN is the completeness of the coverage of its sensors for tracking a list of targets. The completeness of coverage depends on both sensor-specific and target-specific factors. The sensor-specific factors may include sky coverage of the sensors, slew rates, weather at the sensor sites, availability of the sensors, scheduling and targeting algorithms, re-targeting speed, and so on. The target-specific factors include number of targets, altitudes, inclinations, and so on.

One way to evaluate the performance of an SSN design is to perform a computer simulation of the operation of the devices of the SSN. In addition, any simulation of the SSN should also model the tens of thousands of orbiting objects including their reflective properties and their orbital motions. Computer simulation techniques may be classified as continuous models or discrete models with the discrete models being further classified as either time-stepped models or event-driven models. With a time-stepped model, the simulation times at which the state of the simulation changes are known in advance and typically increase by a constant amount at each step of the simulation. With an event-driven model, the simulation times at which the state of the simulation changes are dynamically computed as the simulation progresses with no advance knowledge of those times or assumption that time increases by a constant amount. A simulation that employs the event-driven model is referred to as a discrete event simulation (“DES”).

A DES model is composed of a flat set of “logical processes” that implement various algorithms of the simulation (e.g., simulating an image collected by a telescope). Each logical process has its state that is updated by the logical process based on event messages that are received. Each logical process may be implemented as an operating system (“OS”) process with its own address space and associated overhead for creating and destroying the OS process. The logical processes communicate and synchronize their processing using inter-process communication facilities of the OS. The state of the DES is the collection of the states of its logical processes. When a logical process receives an event message and subsequently changes its state—the event—the logical process may send event messages (i.e., scheduling an event) to other logical processes that in turn update their states and send event messages to other logical processes. Each logical process may have an “event method” represented by the signature m(t, a₁, . . . , aₙ) where t is event time and a₁, . . . , aₙ are parameters passed to the logical process. The invoking of an event method of logical process p may be represented as p.m (t, a₁, . . . , aₙ). When the event method of logical process p is invoked passing event time t, logical process p may invoke an event method q.m(t′, b₁, . . . , bᵣ) of logical process q where event time t′ is greater than event time t. In such a case, the event p.m(t, a₁, . . . , aₙ) is said to have a direct causal relationship with the event q.m(t′, b₁, . . . , bᵣ). A sequence of events e₁, . . . , e_{q}, each having a direct causal relationship with the next, forms a causal chain by transitivity. Each event in a causal chain is a causal antecedent of all of the following ones.

A DES model may be implemented as either a sequential algorithm or a parallel algorithm. A sequential DES is organized at runtime around a central shared priority queue containing all scheduled events, referred to as the event queue. An event p.m(t, a₁, . . . , aₙ) in the event queue is said to be scheduled for a simulation time corresponding to the event time t. A sequential simulation starts with one or more initial events in the event queue. The simulation proceeds by repeatedly removing the event with the earliest event time from the event queue, setting the simulation time to that event time, and then executing the event, which usually has the side effect of inserting one or more future events into the event queue. The simulation terminates normally when some threshold simulation time is reached, although it may also terminate abnormally when the event queue is empty.

A parallel DES (“PDES”) is organized so that the logical processes can be executed in parallel (e.g., on different cores, processors, or nodes of a multi-processor system) and generally without any shared memory. Where there is no shared memory, a PDES employs a distributed event queue rather than a central event queue that is shared by the logical processes. With a distributed event queue, each logical process maintains a local event queue of its scheduled events. FIG. 1 illustrates the logical processes of a PDES and their local event queues. The logical processes 101a-106a are represented by circles, and the local event queues 101b-106b are represented by rectangles to the left of the corresponding logical processes. In this example, the logical process 103a (enlarged) is currently at simulation time 35.1 and is updating its state as a result of receiving an event message with an event time of 35.1 that was sent to the local event queue 103b. The local event queue 103b is storing event messages with event times of 37.2, 40.4, 47.5, and 61.0. The arc between a logical process and a local event queue of another logical process indicates the sending of event messages from that logical process to the other logical process. For example, the arc between logical process 104a and the local event queue 101b indicates that logical process 104a invokes the event method of the logical process 101a to place an event message in the local event queue 101b.

Each logical process in a PDES processes its event messages in event time order even though the event messages may not arrive in event time order. To take advantage of parallelism, each logical process will typically have different simulation times and not be constrained by having their simulation times synchronized (i.e., all the same). As a result, one logical process may have a simulation time that is well ahead of the simulation time of another logical process. Although the logical processes can have different simulation times, each logical process needs to process its event messages in event time order. A difficulty would occur if a logical process received an event message with an event time that was earlier than the simulation time of the logical process.

To avoid the difficulty of processing messages out of order, a PDES may employ a conservative or an optimistic approach. With a conservative approach, each logical process may rely on lookahead information from the logical processes that send event messages to it. The lookahead information sent from a source logical process to a target logical process represents a guarantee that the source logical process will not send any more event messages to the target logical process with an event time that is earlier than a lookahead time. Upon receiving the lookahead time from all of its source logical processes, a target logical process can process its event messages with event times less than the minimum of the lookahead times. With an optimistic approach, a logical process sets its simulation time to the lowest event time of its local event queue. If the logical process later receives an event message with an event time that is lower than its simulation time, then the logical process rolls back its state, processes that event message, and reprocesses event messages that were processed out of order. In addition, the state of other logical processes that received event messages generated while processing event messages out of order may need to also have their states rolled back.

In a PDES, a logical process needed to simulate a subsystem of the overall system being simulated can be very complex and consume vast amounts of computing resources such as memory and processor cycles. Such a logical process may be a bottleneck that results in an unacceptably slow simulation. For example, when one logical process needs significantly more processing cycles than the other logical processes, the other logical processes may need to wait for significant lengths of time for that one logical process to complete before continuing their processing. In some cases, the amount of memory accessible to a single node of a multi-processor system may not even be large enough to store the state of a logical process. As a result, the PDES may not even be able to run on such a multi-processor system or the logical process may need to be redesigned to swap state between memory and secondary storage. Such swapping of state, however, may mean that the other logical processes wait an unacceptably long time, greatly reducing the benefit of such a parallel simulation.

### BRIEF DESCRIPTION OF THE DRAWINGS

FIG. 1 illustrates the logical processes of a PDES and their local event queues.

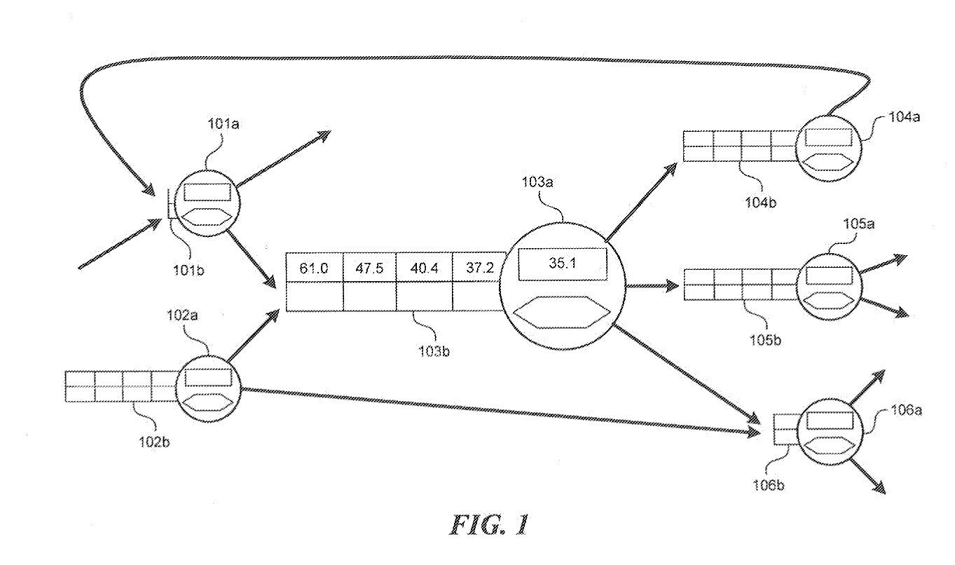

FIG. 2 is a diagram that illustrates logical processes and data stores for an SSN simulation.

FIG. 3 is a diagram that illustrates event queues of a logical process in some embodiments of the IP-PDES system.

FIG. 4 is a diagram that illustrates internal parallelism of a logical process in some embodiments of the IP-PDES system.

FIG. 5 is a block diagram that illustrates the allocation of nodes of a multi-processor computer system for simulation of the SSN using the IP-PDES system in some embodiments.

FIG. 6 is a block diagram that illustrates an OS process for a logical process of the IP-PDES system in some embodiments.

FIG. 7 is a block diagram illustrating threads of a component that is allocated multiple nodes.

FIG. 8 is a flow diagram that illustrates processing of a launch module of the simulator code in some embodiments.

FIG. 9 is a flow diagram that illustrates the processing of a launch module of the CPP runtime in some embodiments.

FIG. 10 is a flow diagram that illustrates the processing of a startup module of the simulator code in some embodiments.

FIG. 11 is a flow diagram that illustrates the processing of a send event message module of the simulator code of the IP-PDES system in some embodiments.

FIG. 12 is a flow diagram that illustrates the processing of a process event message module of a logical process of the IP-PDES system in some embodiments.

### DETAILED DESCRIPTION

A method and system for performing a parallel discrete event simulation for a space surveillance network is provided. In some embodiments, an internally parallel PDES (“IP-PDES”) system performs logical processes in parallel and further performs the internal processing of at least one logical process in parallel. For example, a simulation for the SSN may include logical processes for optical sensors, radars, orbit determinations, object conjunctions, and so on. These logical processes simulate the occurrence of events (e.g., collecting an optical image by a telescope) within the SSN. Because the IP-PDES system is PDES-based, each logical process may have its processing performed in parallel with the other logical processes. For example, the SSN may have 6 telescopes (i.e., optical sensors) and 3 radars with 9 logical processes executing in parallel on 9 nodes (or processors) of a multi-processor computer system. The IP-PDES system allows for certain logical processes to be designated as internally parallel, meaning that that logical process, referred to as an IP logical process, has its internal processing also performed in parallel. The IP-DES system allocates multiple nodes for such an IP logical process so that executable code (e.g., logic) of the IP logical process executes in parallel at the allocated nodes to simulate the occurrence of an event. Internal parallelism within a PDES may help overcome resource limitations and help speed up the overall simulation. As an example of a resource limitation, an optical image generated by a telescope logical process may have so many picture elements (e.g., 32×10¹²) that the image cannot fit into the memory of a single node. In such a case, a telescope logical process may be developed so that each node is assigned a portion of the optical image (e.g., 1×10¹²). Each of the nodes (e.g., 32) can then generate its portion of the optical image in parallel with the other nodes. Moreover, even if the optical image could fit into the memory of a single node, it may be desirable to have the internal processing of the telescope logical process performed in parallel to speed up the overall simulation—especially when the time needed for different logical processes to generate their events varies greatly. In this way, the IP-PDES not only allows the processing of different logical processes to be performed in parallel but also allows internal processing of a logical process to be further performed in parallel.

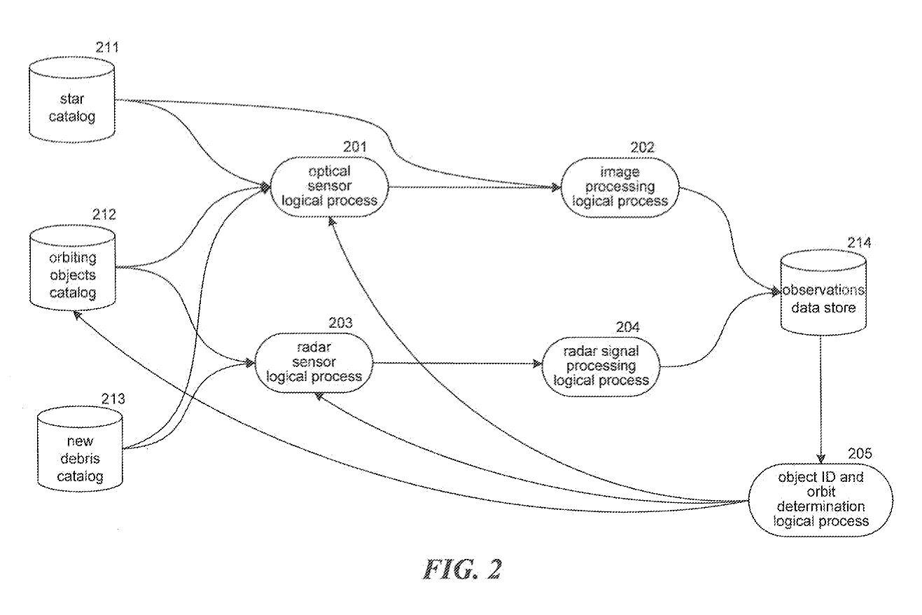

FIG. 2 is a diagram that illustrates logical processes and data stores for an SSN simulation. The logical processes include an optical sensor logical process 201, an image processing logical process 202, a radar sensor logical process 203, a radar signal processing logical process 204, and an object ID and orbit determination logical process 205. The data stores include a star catalog 211, an orbiting objects catalog 212, a new debris catalog 213, and an observations data store 214. The optical sensor logical process 201 simulates optical images that are collected by a telescope based on the star catalog 211, the orbiting objects catalog 212, and the new debris catalog 213 along with object identification and orbit information provided by the object ID and orbit determination logical process 205. The image processing logical process 202 isolates streaks in the optical images that represent orbiting objects and updates the observations data store 214. The object ID and orbit determination logical process 205 identifies the various objects (e.g., satellites) from the observations and determines their orbits. The object identification and orbit determinations are provided to the optical sensor logical process 201 and the radar sensor logical process 203. The radar sensor logical process 203 and the radar signal processing logical process 204 operate in a manner analogous to the optical sensor logical process 201 and the image processing logical process 202.

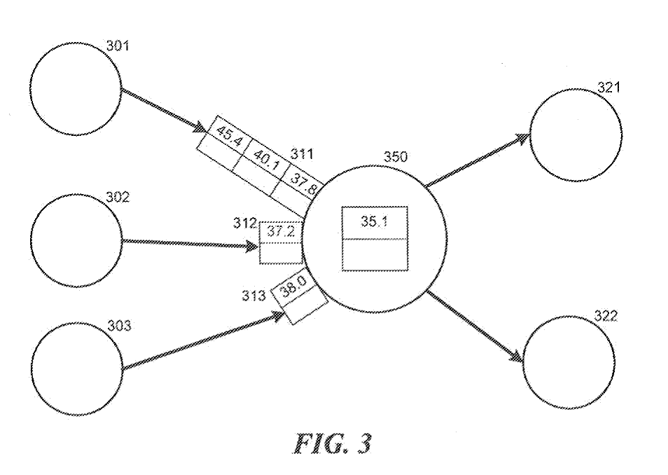

FIG. 3 is a diagram that illustrates event queues of a logical process in some embodiments of the IP-PDES system. A target logical process 350 receives event messages from source logical processes 301, 302, and 303. The target logical process maintains separate event queues 311, 312, and 313, one for each source logical process. The target logical process also sends event messages to logical processes 321 and 322. In this example, event queue 311 includes messages with event times of 37.8, 40.1, and 45.4; event queue 312 includes a message with an event time of 37.2; and event queue 313 includes an event message with an event time of 38.0. The target logical process is currently updating its state to reflect the event associated with the event message with an event time of 35.1. The IP-PDES can be implemented as a conservative or optimistic simulator. If the simulator is conservative and one of the three event queues is empty, then the target logical process cannot continue its processing because it will not know whether the next event message to be placed in that event queue will have an earlier event time than the earliest event time of the other two event queues. To increase parallelism, the IP-PDES system may use lookahead messages indicating minimum time of next event messages from source logical processes so that the target logical process can determine whether it can proceed with processing an event from another event queue. If the simulator is optimistic, then the IP-PDES system would need to roll back its state when event messages are processed out of order.

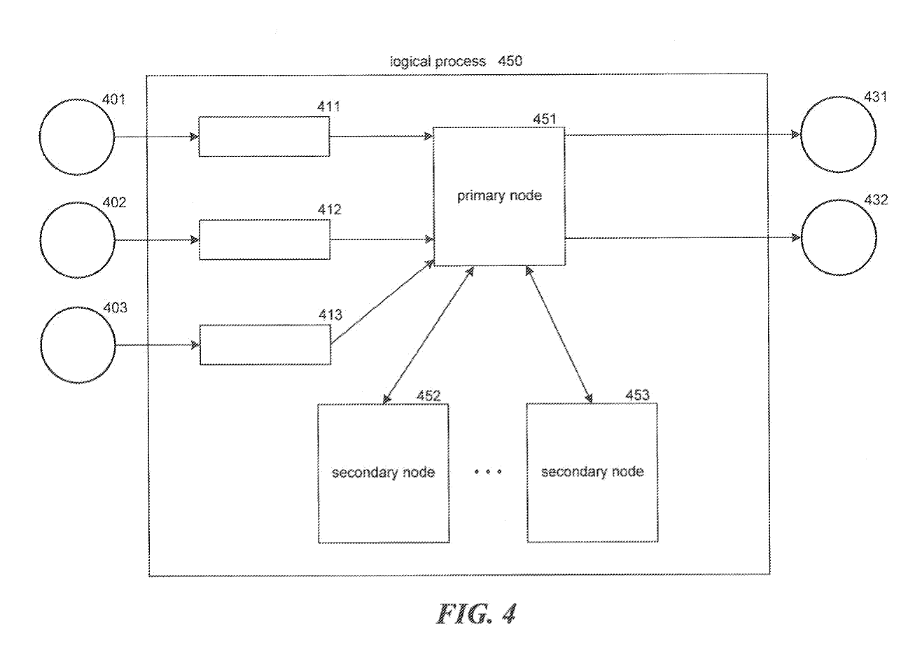

FIG. 4 is a diagram that illustrates internal parallelism of a logical process in some embodiments of the IP-PDES system. The target logical process 450 is an IP logical process that receives event messages from source logical processes 401, 402, and 403. The event messages are stored in the event queues 411, 412, and 413. The target logical process also sends event messages to logical processes 431 and 432. The target logical process 450 is allocated multiple nodes 451, 452, and 453. One node 451 is designated as the primary node of the target logical process 450, and the other nodes 452-453 are designated as secondary nodes. The primary node is responsible for identifying the next event message to be processed by the target logical process 450 and coordinates the generating of the event for that next event message to be performed in parallel at the nodes of the target logical process 450.

In some embodiments, the IP-PDES system assigns each logical process of a simulation to be executed as a component of a cooperative parallel programming (“CPP”) system. A cooperative parallel programming system is described in Jefferson, D., Barton, N., Becker, R., Hornung, R., Knap, J., Kumfert, G., Leek, J., May, J., Miller, P., and Tannahill, J., “Overview of the Cooperative Parallel Programming Model,” UCRL-CONF-230029, which is hereby incorporated by reference. A CPP system allows components (e.g., executables) to run on different cores, processors, or generally nodes in parallel and allows components to have internal parallelism. The CPP system may create an operating system (“OS”) process at each node that is allocated to a logical process. A CPP system provides a remote method invocation (“RMI”) functionality that allows invocation of a method or function of a component via an interface exposed by that component. A CPP system may provide a CPP runtime that is linked into the executable of a logical process to provide support for an RMI. When a method of a component is invoked via an RMI, the CPP system identifies the primary node (or primary OS process) of that component and passes an indication of the invocation (e.g., actual arguments) to that node. An RMI can be blocking or non-blocking, also referred to as a synchronous or asynchronous invocation. A method that is invoked by an RMI can be either a sequential body or a parallel body method. A sequential body method is designed to have only one instance executed at a time—no internal parallelism. A parallel body method is designed to have multiple instances executed at the same time—internal parallelism. When a parallel body method of a component is invoked with RMI, the CPP system executing on the primary node of that component launches a thread on each of the nodes (including the primary node) allocated to the component to execute that method in parallel. The threads may communicate using a message passing interface (“MPI”) to synchronize their execution. For example, a thread may use a locking mechanism to coordinate access to a data structure. When a thread executing at a secondary node completes, it notifies the thread executing at the primary node. When all the threads complete, the execution of the parallel body method via an RMI completes. The CPP system creates and destroys threads within OS processes to execute the parallel body method.

In some embodiments, the IP-PDES system may use a sequential body method to send an event message between logical processes and use a parallel body method to process an event message in parallel by the receiving or target logical process. For example, a main thread executing at the primary node for a telescope logical process may receive event messages, queue the event messages, and select the event message to process next. When an event message is to be processed for the telescope logical process, the main thread of the primary node (or primary OS process) invokes a parallel body method of the telescope logical process via an RMI. The CPP system then creates an RMI thread on each of the nodes allocated to the telescope logical process to execute the method in parallel (i.e., generate the optical image for the telescope). When all the RMI threads complete, the telescope logical process can then process the next event message.

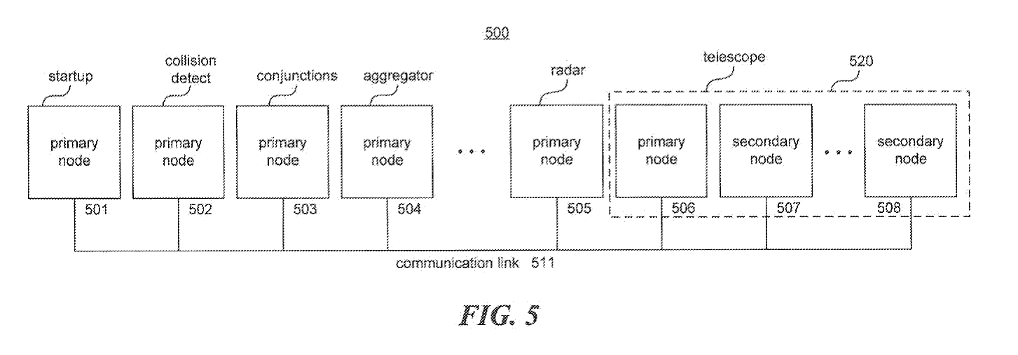

FIG. 5 is a block diagram that illustrates the allocation of nodes of a multi-processor computer system for simulation of the SSN using the IP-PDES system in some embodiments. The multi-processor computer system 500 includes nodes 501-508 connected via a communications link 511. In this example, the logical processes include a startup logical process, a collision detect logical process, a conjunctions logical process, an aggregator logical process, a radar logical process, and a telescope logical process. Each logical process corresponds to a component of the CPP system that may be allocated to one or more nodes. In this example, each component is allocated to only one node, except for the component corresponding to the telescope logical process. The startup logical process, the collision detect logical process, the conjunctions logical process, the aggregator logical process, and the radar logical process have each been allocated a node 501-505. A component 520 corresponding to the telescope logical process has been allocated multiple nodes 506-508. Node 506 is the primary node for the telescope logical process, and nodes 507-508 are secondary nodes for the telescope logical process. The nodes communicate via the communications link using a message passing interface that may employ a variety of underlying protocols such as TCP/IP.

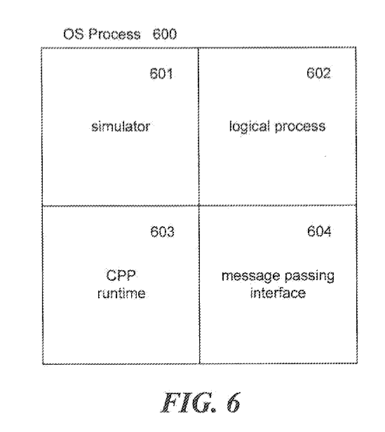

FIG. 6 is a block diagram that illustrates an OS process for a logical process of the IP-PDES system in some embodiments. The OS process 600 includes simulator code 601, logical process code 602, CPP runtime 603, and MPI code 604. The simulator code provides support for sending and receiving event messages and maintaining the various event queues. The logical process code represents the implementation of the logical process such as the code for generating an optical image collected by a telescope. The CPP runtime provides an interface for invocation of sequential and parallel body methods via RMI. When the simulator code determines that an event message is to be processed, the simulator code interfaces with the CPP runtime to invoke a parallel body method of the logical process to process the event message. The CPP runtime notifies the nodes allocated to that logical process to create a thread to execute the body of the invoked method. The MPI code provides an interface for sending inter-process and inter-node communications.

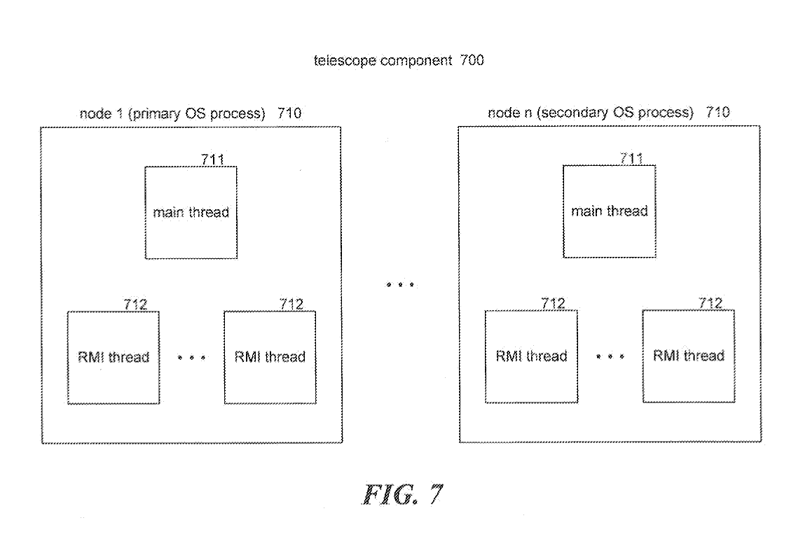

FIG. 7 is a block diagram illustrating threads of a component that is allocated multiple nodes. In this example, a telescope component 700 has been allocated multiple nodes 710. One of the nodes is designated as the primary node that is executing the primary OS process of the telescope component, and the other nodes are designated as secondary nodes that are executing secondary OS processes of the telescope component. Each OS process includes a main thread 711 and RMI threads 712. The main thread of the primary OS process selects an event message and requests the CPP runtime to execute a parallel body method of the logical process for processing that event message. The CPP runtime executing in the primary OS process of the primary node notifies the nodes allocated to the telescope logical process to process the event message by executing that method in an RMI thread of that node.

The computer system on which the IP-PDES system may be implemented may be a multi-processor computer system with nodes, may include a central processing unit and memory, and may include input devices (e.g., keyboard and pointing devices), output devices (e.g., display devices), and storage devices (e.g., disk drives). Each node may include multiple processors and/or cores. Computer-readable media include computer-readable storage media and data transmission media. The computer-readable storage media include memory and other storage devices that may have recorded upon or may be encoded with computer-executable instructions or logic that implement the IP-PDES system. The data transmission media is media for transmitting data using signals or carrier waves (e.g., electromagnetism) via a wire or wireless connection

The IP-PDES system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

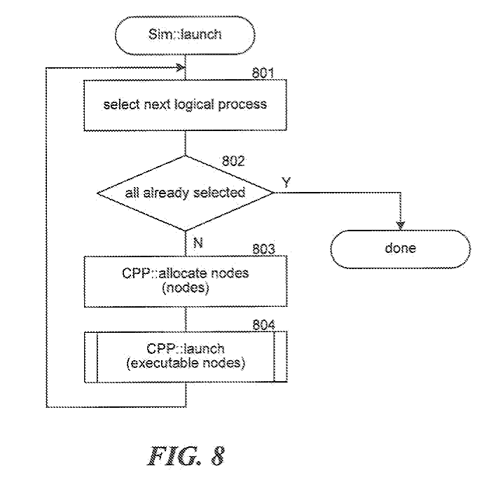

FIG. 8 is a flow diagram that illustrates processing of a launch module of the simulator code in some embodiments. The launch module is executed at the start of a simulation and is passed an indication of the logical processes of the simulation and the number of nodes to be allocated to each logical process. Alternatively, the launch module may be provided an indication that a logical process is internally parallel and dynamically allocate nodes to that logical process as needed. In block 801, the module selects the next logical process. In decision block 802, if all the logical processes have already selected, then the module completes, else the module continues at block 803. In block 803, the module invokes an allocate module of the CPP runtime to allocate nodes for the selected logical process. In block 804, the module invokes a launch module of the CPP runtime passing an indication of the executable of the logical process and the allocated nodes to launch the logical process as a component of the CPP system. The module then loops to block 801 to select the next logical process.

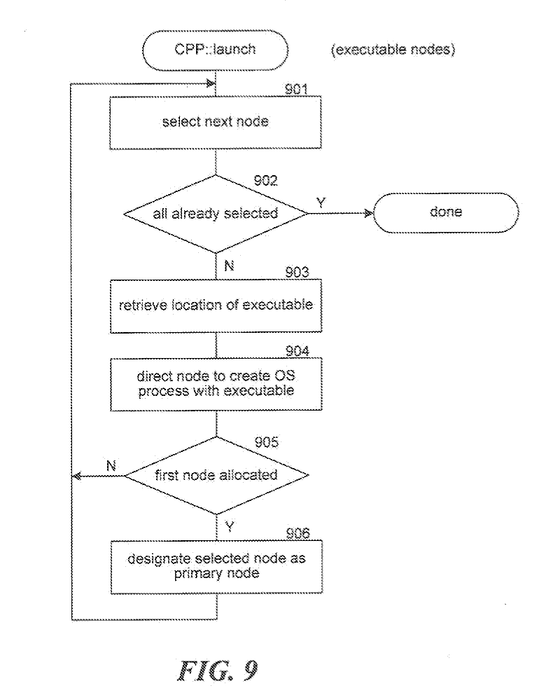

FIG. 9 is a flow diagram that illustrates the processing of a launch module of the CPP runtime in some embodiments. The module is passed an indication of an executable for a logical process and the nodes on which the executable is to execute. In block 901, the module selects the next passed node. In decision block 902, if all the passed nodes have already been selected, then the module completes, else the module continues at block 903. In block 903, the module retrieves the location of the passed executable. In block 904, the module directs the selected node to create an OS process with the executable. In decision block 905, if this is the first node to be processed for this logical process, then the module continues at block 906, else the module. loops to block 901 to select the next passed node. In block 906, the module designates the selected node as the primary node and loops to block 901 to select the next passed node.

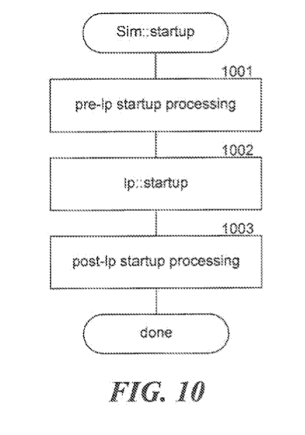

FIG. 10 is a flow diagram that illustrates the processing of a startup module of the simulator code in some embodiments. The startup module is executed within the primary OS process of a component to create the event queues and invoke a startup module of the component to initialize the logical process (“Ip”.) In block 1001, the module performs initialization prior to initialization of the logical process. For example, the module may create for a target logical process an event queue for each source logical process. In block 1002, the module invokes a startup module of the logical process to initialize the logical process. For example, the startup module of a telescope logical process may notify the nodes allocated to the telescope logical process of the portion of the optical image that each is assigned to generate. In block 1003, the module performs further initialization after initialization of the logical process and then completes. For example, the module may send a communication to the node in control of launching the simulation to indicate that the logical process is now initialized.

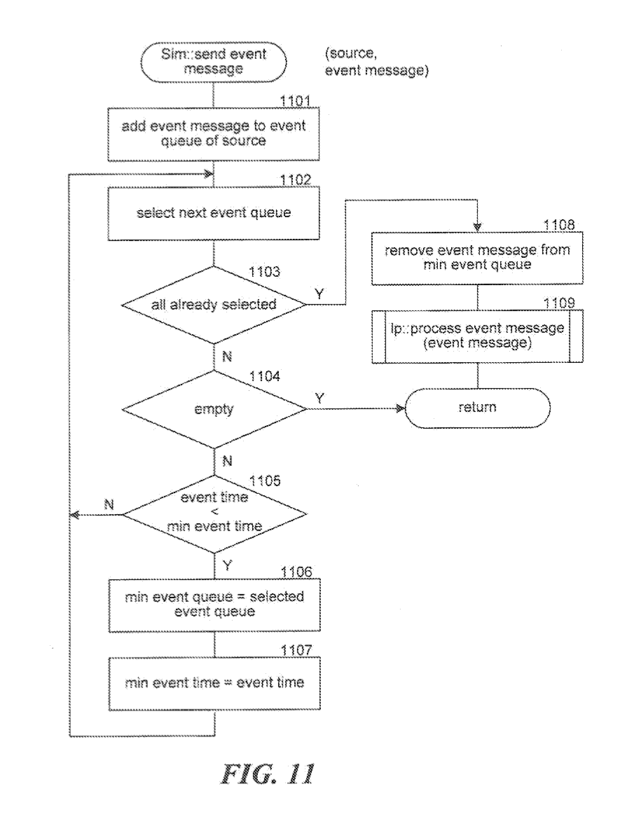

FIG. 11 is a flow diagram that illustrates the processing of a send event message module of the simulator code of the IP-PDES system in some embodiments. The module is passed an indication of the source logical process and the event message. The module may be a sequential body method that is invoked via an RMI. The module adds the event to the appropriate event queue and determines whether to process the next event message. In block 1101, the module adds the event message to the event queue for the source logical process. In blocks 1102-1107, the module loops determining whether an event message can be processed. In block 1102, the module selects the next event queue. In decision block 1103, if all the event queues have already been selected, then the module continues at block 1108, else the module continues at block 1104. In decision block 1104, if the selected event queue is empty, then an event message cannot yet be processed and the module returns, else the module continues at block 1105. The module may also be implemented using lookahead times as discussed above. In decision block 1105, if the event time of the event message of the selected event queue is less than any minimum event time encountered during the current invocation of the module, then the module continues at block 1106, else the module loops to block 1102 is to select the next event queue. Alternatively, the IP-PDES system may have separate threads for adding event messages to the event queues of a component and for selecting the next event message to process. In block 1106, the module sets the minimum event queue to the selected event queue. In block 1107, the module sets the minimum event time to the event time of the event message at the top of the selected event queue and loops to block 1102 to select the next event queue. In block 1108, the module removes the event message from the minimum event queue. In block 1109, the module invokes a parallel body method of the logical process using RMI passing the event message to generate the event. The module then returns.

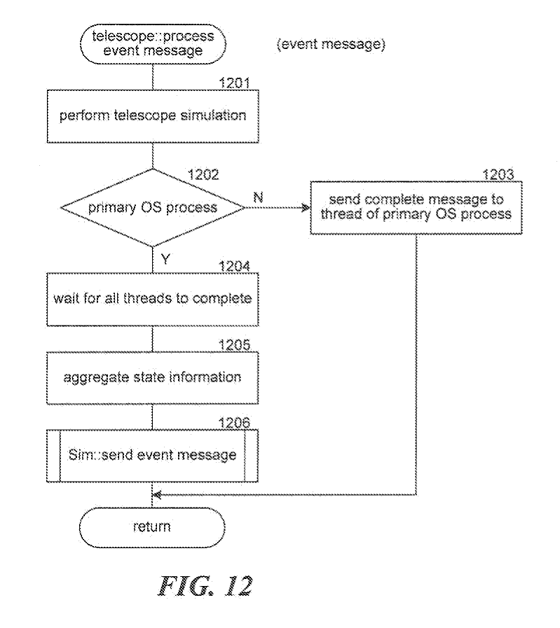

FIG. 12 is a flow diagram that illustrates the processing of a process event message module of a logical process of the IP-PDES system in some embodiments. Each logical process of the simulation provides an implementation of this module, which is a parallel body method when the logical process is internally parallel. The component is passed an event message and updates its internal state to reflect the occurrence of the event. In block 1201, the module updates the state of the logical process to reflect the occurrence of the event. For example, a telescope logical process generates an optical image to simulate collection of an image by a telescope. In decision block 1202, if this is the primary OS process for the logical process, then the module continues at block 1204, else the module continues at block 1203. In block 1203, the module sends a notification to the primary OS process indicating that this thread has completed and then returns. In block 1204, the module waits for all other threads that are executing in parallel for this invocation to send their notifications of completion. In block 1205, the module aggregates the state information as appropriate. In block 1206, the module sends event messages as defined by the logical process and then returns.

From the foregoing, it will be appreciated that specific embodiments of the invention have been described herein for purposes of illustration but that various modifications may be made without deviating from the scope of the invention. Accordingly, the invention is not limited except as by the appended claims.

I/we claim:

1. A computer-readable storage medium storing computer-executable instructions for controlling a computer system to perform a parallel discrete event simulation, by a method comprising:
accessing a specification of logical processes for the parallel discrete event simulation, the specification indicating that at least one logical process is to have its processing performed in parallel;
when a target logical process is to have its processing performed in parallel, allocating multiple nodes for the target logical process, each of the allocated nodes to perform processing of the target logical process in parallel with the other allocated nodes, one of the allocated nodes being a primary node of the target logical process;
sending an event message from a source logical process to the primary node of the target logical process;
upon receiving the event message at the primary node of the target logical process, storing the event message in an event queue of the target logical process; and
when the target logical process is to perform an event for the event message in the event queue, invoking a parallel function to perform the processing of the target logical process. such that logic of the function is performed in parallel at the allocated nodes.

2. The computer-readable storage medium of claim 1 including when a logical process is not to have its processing performed in parallel, allocating a single node for that process.

3. The computer-readable storage medium of claim 1 wherein the parallel discrete event simulation simulates output of sensors of a space surveillance network.

4. The computer-readable storage medium of claim 3 wherein the target logical process generates output of an optical sensor of the space surveillance network.

5. The computer-readable storage medium of claim 3 wherein the target logical process generates output of a radar of the space surveillance network.

6. The computer-readable storage medium of claim 1 wherein when the parallel function is invoked, assigning a thread at each of the nodes allocated to the target logical process to perform logic of the function in parallel.

7. The computer-readable storage medium of claim 1 wherein the target logical process receives event messages from multiple source logical processes and processes an event message in event time order as long as at least one event message has not yet been processed for each source logical process.

8. The computer-readable storage medium of claim 7 wherein the target logical process has multiple event queues with one for each of the multiple source logical processes.

9. A computer system for performing a parallel discrete event simulation, comprising:
a data store that stores a specification of logical processes for the parallel discrete event simulation, each logical process to have its processing performed in parallel with the other logical processes, the specification for a target logical process indicating that its internal processing is to be performed in parallel;
a component that allocates processors to the logical processes wherein the target logical process is allocated multiple processors;
a component that, when the target logical process is to process an event message, invokes a parallel function to perform the internal processing of the target logic process in parallel by the allocated multiple processors
so that the processing of different logical processes is performed in parallel and the internal processing of the target logical process is further performed in parallel.

10. The computer system of claim 9 wherein one of the processors allocated to the target logical process is designated as a primary processor that receives event messages and directs the allocated processors of the target logical process to perform processing of the event messages in parallel.

11. The computer system of claim 9 wherein the parallel discrete event simulation simulates output of sensors of a space surveillance network.

12. The computer system of claim 11 wherein the target logical process generates output of an optical sensor of the space surveillance network.

13. The computer system of claim 11 wherein the target logical process generates output of a radar of the space surveillance network.

14. The computer system of claim 9 wherein when the parallel function is invoked, a thread at each of the processors allocated to the target logical process performs logic of the function in parallel.

15. The computer system of claim 9 wherein the target logical process receives event messages from multiple source logical processes and processes an event message in event time order when an event message is pending from each of the multiple source logical processes.

16. The computer system of claim 9 wherein the target logical process has multiple event queues with one for each of multiple source logical processes that send event messages to the target logical process.

17. A method in a computer system for performing a parallel discrete event simulation for a space surveillance network, the method comprising:
providing a specification of logical processes for the parallel discrete event simulation, each logical process to have its processing performed in parallel with the other logical processes, the specification for a target logical process indicating that its internal processing is to be performed in parallel, the target logical process for generating a simulated optical image of an optical sensor;
allocating processors to the logical processes wherein the target logical process is allocated multiple processors;
when the target logical process is to process an event message, invoking a parallel function to perform the internal processing of the target logic process in parallel by the allocated multiple processors, wherein each of the multiple processors generates a portion of the simulated optical image
so that the processing of different logical processes is performed in parallel and the internal processing of the target logical process is further performed in parallel.

18. The method of claim 17 wherein one of the processors allocated to the target logical process is designated as a primary processor that receives event messages and directs the allocated processors of the target logical process to perform processing of the event messages in parallel.

19. The method of claim 17 wherein when the parallel function is invoked, a thread at each of the processors allocated to the target logical process performs logic of the function in parallel to generate the simulated optical image.

20. The method of claim 17 wherein the target logical process receives event messages from multiple source logical processes and processes an event message in event time order when an event message is pending from each of the multiple source logical processes.
